(19) United States
(12) Patent Application Publication
(10) Pub. No.: US 2025/0098744 A1
(43) Pub. Date: Mar. 27, 2025

(54) AEROSOL GENERATING DEVICE AND METHOD

(71) Applicant: KT&G CORPORATION, Daejeon (KR)

(72) Inventors: Ju Eon PARK, Gyeonggi-do (KR); Tae Hun KIM, Gyeonggi-do (KR); Sung Wook YOON, Gyeonggi-do (KR); Hyung Jin JUNG, Seoul (KR); Jung Ho HAN, Daejeon (KR)

(73) Assignee: KT&G CORPORATION, Daejeon (KR)

(21) Appl. No.: 18/563,441

(22) PCT Filed: Jun. 20, 2023
(86) PCT No.: PCT/KR2023/008543

§ 371 Date: Nov. 22, 2023

(30) Foreign Application Priority Data
Jun. 22, 2022 (KR) 10-2022-0076375
Oct. 26, 2022 (KR) 10-2022-0139436

(51) Int. Cl. A24F 40/20; A24F 40/42; A24F 40/51; A24F 40/53; G01F 23/263

(52) U.S. Cl. CPC A24F 40/20; A24F 40/42; A24F 40/51; A24F 40/53; G01F 23/268

(57) ABSTRACT

An aerosol generating device includes a main body including a semi-exterior portion having an accommodation space into which a cigarette is inserted, a cartridge detachably coupled to the semi-exterior portion, an antenna arranged on a surface of the semi-exterior portion to face a surface of the cartridge, a sensor configured to sense a capacitance of the antenna, and a controller electrically connected to the sensor. The controller is configured to determine, based on the capacitance, a residual quantity of an aerosol generating material in the cartridge and whether or not the cartridge is detached.

### TECHNICAL FIELD

The disclosure relates to an aerosol generating device and method. In detail, the disclosure relates to an aerosol generating device capable of detecting, through a capacitance sensor, whether or not a cartridge is detached and a liquid residual quantity of the cartridge.

### BACKGROUND ART

Recently, the demand for smoking methods to replace traditional cigarettes has increased. For example, there is growing demand for an aerosol generating method for generating aerosol by heating an aerosol generating material in cigarettes, rather than by combusting cigarettes. Accordingly, research into a heating-type cigarette or a heating-type aerosol generating device has been actively conducted.

An aerosol generating device may include a cartridge for generating aerosol. The cartridge may include a storage for storing an aerosol generating material and an atomizer for vaporizing the aerosol generating material. In order for the aerosol generating device to safely and normally operate, information about whether or not the cartridge is detached and a liquid residual quantity of the cartridge may be required.

### DISCLOSURE OF INVENTION

### Technical Problem

The disclosure provides an aerosol generating device and method for obtaining information about whether or not a cartridge is detached and a liquid residual quantity of the cartridge with low power consumption.

Also, the disclosure provides an aerosol generating device and method for correcting an error in liquid residual quantity information according to an inclination of a cartridge.

The problems to be solved by one or more embodiments are not limited to those described above, and other objectives that are not described may be clearly understood by one of ordinary skill in the art from the present specification and the accompanying drawings.

### Solution to Problem

An aerosol generating device according to an embodiment of the disclosure includes a main body including a semi-exterior portion having an accommodation space into which a cigarette is inserted, a cartridge detachably coupled to the semi-exterior portion, an antenna arranged on a surface of the semi-exterior portion to face a surface of the cartridge, a sensor configured to sense a capacitance of the antenna, and a controller electrically connected to the sensor. The controller is configured to determine, based on the capacitance, a residual quantity of an aerosol generating material in the cartridge and whether or not the cartridge is detached.

An operating method of an aerosol generating device including a main body including a semi-exterior portion having an accommodation space into which a cigarette is inserted, a cartridge detachably coupled to the semi-exterior portion, an antenna arranged on a surface of the semi-exterior portion to face a surface of the cartridge, and a sensor configured to sense a capacitance of the antenna, according to an embodiment of the disclosure, includes applying a driving signal to the antenna, receiving a sensing signal corresponding to the driving signal from the antenna, and determining, based on the sensing signal, a residual quantity of an aerosol generating material in the cartridge and whether or not the cartridge is detached.

### Advantageous Effects of Invention

An aerosol generating device and method according to various embodiments of the disclosure may obtain, by using a cartridge sensor, information about whether or not a cartridge is detached and a liquid residual quantity of the cartridge.

The effects according to one or more embodiments are not limited to those described above, and other advantages that are not described may be clearly understood by one of ordinary skill in the art from this specification and the accompanying drawings.

### BRIEF DESCRIPTION OF DRAWINGS

FIG. 1 is a perspective view of an aerosol generating device into which an aerosol generating article is inserted, according to an embodiment.

FIG. 2 is an exploded side view schematically illustrating an exterior shape of an aerosol generating device according to an embodiment.

FIG. 3 is a cross-sectional view for describing internal components of an aerosol generating device according to an embodiment.

FIG. 4 is an exploded view of some components of an aerosol generating device according to an embodiment.

FIG. 5A is a view of a surface of an antenna cover.

FIG. 5B is a view of another surface of the antenna cover.

FIG. 6A is a view for describing a sensor according to an embodiment.

FIGS. 6B to 6D are views for describing an operation of a sensor according to an embodiment.

FIGS. 7A and 7B are graphs showing a change of the total amount of capacitance according to a residual quantity of an aerosol generating material (or a liquid) in a cartridge.

FIG. 8 is a block diagram of an aerosol generating device according to another embodiment.

FIG. 9 is a flowchart for describing a method of detecting a residual quantity of an aerosol generating material and determining whether or not a main body is detached in an aerosol generating device.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, an embodiment of the disclosure will be described in detail with reference to the accompanying drawings so that one of ordinary skill in the art may easily execute the embodiment of the disclosure. However, the disclosure may be embodied in many different forms and should not be construed as being limited to the embodiments set forth herein.

Hereinafter, embodiments of the disclosure will be described in detail with reference to the drawings.

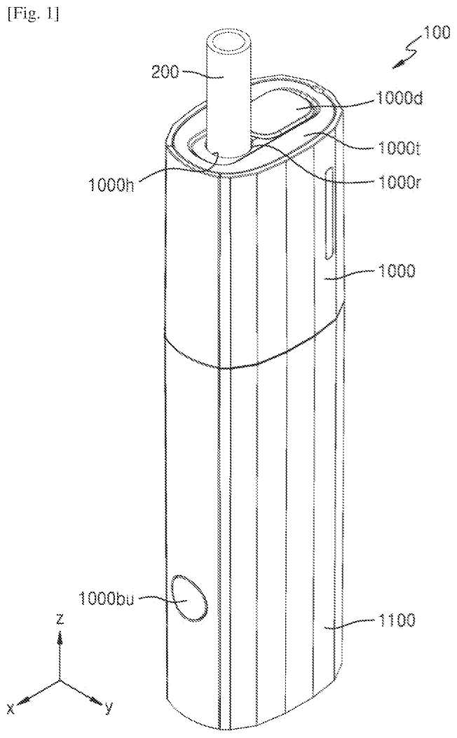

FIG. 1 is a perspective view of an aerosol generating device into which an aerosol generating article is inserted, according to an embodiment.

Referring to FIG. 1, an aerosol generating device 100 according to an embodiment may include a cover 1000 and a main body 1100.

The cover 1000 may be coupled to one end of the main body 1100, so that the main body 1100 and the cover 1000 may together form an exterior shape of the aerosol generating device 100. An external hole 1000h through which a cigarette 200 may be inserted may be formed in an upper surface of the cover 1000 coupled to the main body 1100.

The main body 1100 may form a portion of the exterior shape of the aerosol generating device 100 and may accommodate and protect components of the aerosol generating device 100. For example, a battery (not shown), a processor (not shown), and/or a heater (not shown) may be accommodated in the main body 1100. However, the disclosure is not limited thereto. Also, the main body 1100 may accommodate the cigarette 200 inserted through the external hole 1000h.

The main body 1100 and the cover 1000 may be formed of a plastic material with low conductivity, or a metal material, a surface of which is coated with a heat-blocking material. The main body 1100 and the cover 1000 may be, for example, formed by injection molding, three-dimensional (3D) printing, or assembling of small components formed by injection molding.

A maintaining device (not shown) for maintaining a coupling state of the main body 1100 and the cover 1000 may be formed between the main body 1100 and the cover 1000. The maintaining device may include, for example, a protrusion and a groove. The coupling state of the cover 1000 and the main body 1100 may be maintained by maintaining a state in which the protrusion is inserted into the groove, and the protrusion may be separated from the groove as the protrusion moves according to a user input applied to a manipulation button.

The external hole 1000h through which the cigarette 200 may be inserted may be formed in the upper surface of the cover 1000 coupled to the main body 1100. Also, a rail 1000r may be formed on a position of the upper surface of the cover 1000 to be adjacent to the external hole 1000h. A door 1000d capable of a sliding movement along the upper surface of the cover 1000 may be formed at the rail 1000r. The door 1000d may linearly slide along the rail 1000r. A top plate 1000t in which an opening is formed along a movement path of the door 1000d may be arranged on the upper surface of the cover 1000.

The door 1000d may move along the rail 1000r so as to externally expose the external hole 1000h, through which the cigarette 200 may be inserted into the main body 1100 by passing through the cover 1000.

When the door 1000d is open and the external hole 1000h is exposed to the outside, a user may insert the cigarette 200 into the external hole 1000h and an insertion hole (not shown) to mount the cigarette 2000 in an accommodation passage (not shown) formed in the cover 1000.

The rail 1000r may have a groove. However, according to an embodiment, the rail 1000r is not limited to a particular structure. For example, the rail 1000r may be a protrusion and may extend in a curved shape rather than a linear shape.

A manipulation button 1100bu may be formed in the main body 1100. As the manipulation button 1100bu is manipulated, operations of the aerosol generating device 100 may be controlled.

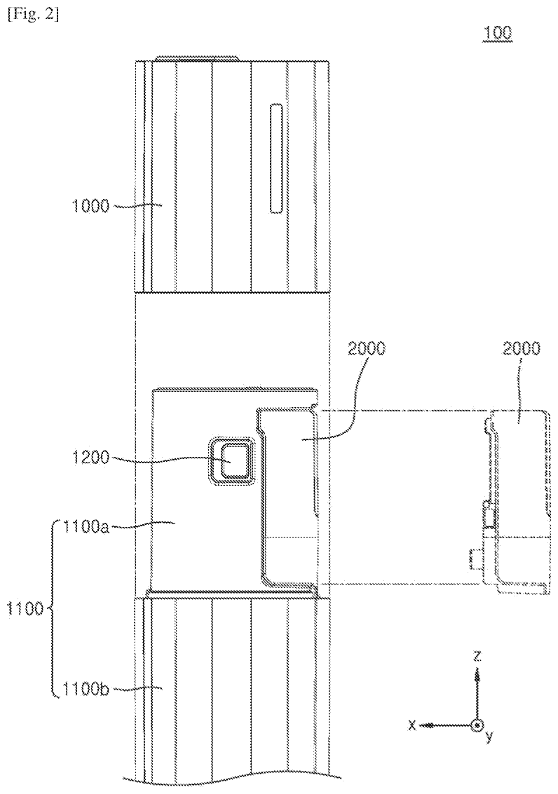

FIG. 2 is an exploded side view schematically illustrating an exterior shape of an aerosol generating device according to an embodiment.

Referring to FIG. 2, the aerosol generating device 100 according to an embodiment may include the cover 1000, the main body 1100, a button 1200, and a cartridge 2000.

The main body 1100 may include a semi-exterior portion 1100a into which the cigarette 200 is inserted and to which the cartridge 2000 is coupled, and a bottom case 1100b supporting and protecting various components mounted in the main body 1100. Hereinafter, the “main body” 1100 denotes both of the semi-exterior portion 1100a and the bottom case 1100b.

The cover 1000 may be released from the coupling with the main body 1100 and may be separated from the main body 1100. For example, the cover 1000 may be separated from the main body 1100 in a +z direction. When the cover 1000 is separated from the main body 1100, the semi-exterior portion 1100a of the main body 1100, the button 1200, and the cartridge 2000 may be exposed to the outside.

The button 1200 may be arranged such that at least a portion of the button 1200 is exposed to the outside of the semi-exterior portion 1100a, and according to a user's input, the button 1200 may release the clamping relationship between the main body 1100 and the cartridge 2000. For example, when the user's input is applied to the button 1200, the cartridge 2000 may be detached from the semi-exterior portion 1100a.

The cartridge 2000 may store an aerosol generating material and may be detachably coupled to one end of the semi-exterior portion 1100a.

The aerosol generating material may have any one of various states, such as a liquid state, a solid state, a gas state, a gel state, etc. The aerosol generating material may include a liquid composition. For example, the liquid composition may be a liquid including a tobacco-containing material having a volatile tobacco flavor component, or a liquid including a non-tobacco material.

The cartridge 2000 may operate according to an electrical signal, a radio signal, or the like transmitted from the main body 1100 to convert a phase of the aerosol generating material in the cartridge 2000 to a gas phase to generate aerosol. The aerosol may denote a suspension of vaporized particles in the air, which is generated from the aerosol generating material.

According to an embodiment, the cartridge 2000 may be coupled to the main body 1100 including a processor (not shown) and/or a battery (not shown) and may be implemented as a component of the aerosol generating device. For example, a heating element (not shown) included in the cartridge 2000 may be electrically connected to the main body 1100, so that the heating element may receive power from the battery, and power supply to the heating element may be controlled by the processor.

That is, in the aerosol generating device 100 including the cartridge 2000, power may be supplied to the heating element, and the supply of power to the heating element may be controlled, and thus, aerosol may be generated from the aerosol generating material in a liquid state or a gel state that is stored in the cartridge 2000.

That is, the aerosol generating device including the cartridge 2000 may not only generate aerosol by heating the aerosol generating material stored in the cartridge 2000, but may also generate aerosol by heating the cigarette 200 (of FIG. 1) inserted. Accordingly, a hybrid type of aerosol generating device may be realized.

FIG. 2 illustrates that the cartridge 2000 is coupled to the main body 1100 by approaching a side surface of the semi-exterior portion 1100a. However, a coupling method of the cartridge 2000 and the main body 1100 is not limited thereto. For example, like the cover 1000, the cartridge 2000 may be coupled to the main body 1100 by approaching the main body 1100 in a −z direction from a position apart from the main body 1100 in a +z direction.

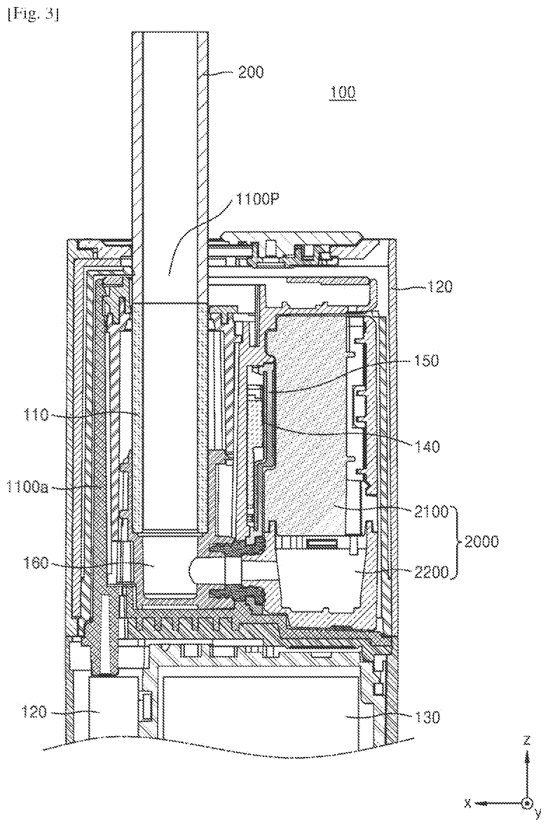

FIG. 3 is a cross-sectional view for describing internal components of an aerosol generating device according to an embodiment.

Referring to FIG. 3, the aerosol generating device 100 according to an embodiment may include a heater 110, a battery 120, a printed circuit board (PCB) 130, an antenna 140, an antenna cover 150, a connection passage 160, and the cartridge 2000 in an internal space.

According to an embodiment, the aerosol generating device 100 may include an accommodation passage 1100p into which the cigarette 200 may be inserted. At least a portion of the cigarette 200 may be inserted into or accommodated in the aerosol generating device 100 through the accommodation passage 1100p.

The cartridge 2000 may include a storage 2100 for storing an aerosol generating material and an atomizer 2200 for vaporizing the aerosol generating material. The aerosol generating device 100 may generate aerosol from the aerosol generating material through the cartridge 2000. The aerosol generated by the cartridge 2000 may be delivered to a user.

The aerosol generating material may include a liquid composition and an aerosol forming agent. The liquid composition may be a liquid including a tobacco-containing material having a volatile tobacco flavor component, or a liquid including a non-tobacco material. For example, the liquid composition may include water, a solvent, ethanol, plant extract, spices, flavorings, or a vitamin mixture. The spices may include menthol, spearmint oil, various fruit flavoring ingredients, and the like, and the flavorings may include ingredients capable of providing various flavors or tastes to a user. Vitamin mixtures may include a mixture of at least one of vitamin A, vitamin B, vitamin C, and vitamin E, but are not limited thereto.

The aerosol forming agent may increase the amount of smoke of the aerosol provided from the aerosol generating device 100. For example, the aerosol forming agent may include at least one of glycerin, propylene glycol, ethylene glycol, dipropylene glycol, diethylene glycol, triethylene glycol, tetraethylene glycol, and oleyl alcohol, but it is not limited thereto. Also, the aerosol forming agent may contain other additives, such as a flavor agent, a wetting agent, and/or an organic acid, or may further contain a flavored liquid, such as menthol or a moisturizer.

The storage 2100 may store the aerosol generating material. When smoking with respect to the aerosol generating device 100 is performed, aerosol generated from the aerosol generating device 100 may be delivered to the user. Thus, the aerosol generating material stored in the storage 2100 may be consumed, and a residual quantity of the aerosol generating material in the storage 2100 may be reduced.

When the residual quantity of the aerosol generating material is changed, it may also be required to change the heating characteristic for vaporizing the aerosol generating material. Also, when the residual quantity of the aerosol generating material becomes insufficient, aerosol provision may be stopped during smoking, or aerosol may not be generated from the aerosol generating device 100. Thus, it may be required to detect the residual quantity of the aerosol generating material in the storage 2100.

In addition, the main body 1100 of the aerosol generating device 100 may include the heater 110 for heating the cigarette 200. Thus, when the heater 110 operates in a state in which the cover 1000 (FIG. 1) is removed, there is the risk of burns for a user. Thus, it may be required to detect whether or not the main body 1100 and the cover 100 are coupled to each other.

The storage 2100 may be formed to have various shapes. The storage 2100 may include an internal space for storing a liquid aerosol generating material and wall surfaces forming the internal space. For example, the storage 2100 may have a cylindrical shape having the internal space formed of a bottom surface, a ceiling surface, and side surfaces. However, the storage 2100 is not limited thereto, and the storage 2100 may be implemented to have other shapes capable of storing a liquid aerosol generating material.

The atomizer 2200 may vaporize the aerosol generating material. The atomizer 2200 may vaporize the aerosol generating material by heating the aerosol generating material stored in the storage 2100. For example, the atomizer 2200 may transport the aerosol generating material to the outside of the storage 2100 and may beat the aerosol generating material transported to the outside.

The atomizer 2200 may include a liquid transportation unit and a heating element. The liquid transportation unit may be configured to transport the aerosol generating material to the outside of the storage 2100, and the heating element may be configured to heat the aerosol generating material transported by the liquid transportation unit to the outside of the storage 2100. For example, the liquid transportation unit may be a wick transporting the aerosol generating material to the outside of the storage 2100, and the heating element may be a coil heating the aerosol generating material transported along the wick.

In detail, the wick may include at least one of cotton fiber, ceramic fiber, glass fiber, and porous ceramic transporting the aerosol generating material through a capillary, and the coil may include a conductive filament, such as a nichrome wire wound around the wick and heated by a supplied current, etc., but is not limited thereto.

The cartridge 2000 may be detachable from the aerosol generating device 100. The cartridge 2000 may be coupled to the aerosol generating device 100 and may generate aerosol, and the cartridge 2000 may be separated from the aerosol generating device 100. For example, the cartridge 2000 may be a consumable that is periodically replaced as the aerosol generating device 100 is used. When the aerosol generating material stored in the storage 2100 of the cartridge 2000 is entirely consumed, the cartridge 2000 may be replaced by the user.

The heater 110 may be positioned in an internal space of the semi-exterior portion 1100a and may generate aerosol by heating the cigarette 200 inserted into the semi-exterior portion 1100a through the accommodation passage 1100p.

The aerosol may be generated as the vaporized particles generated by heating the cigarette 200 and air introduced into the internal space of the semi-exterior portion 1100a through the accommodation passage 1100p are mixed.

For example, the heater 110 may include an induction heater. For example, the heater 110 may include a coil (or an “electrically conductive coil”) generating alternate magnetic fields according to the supply of power and a susceptor generating heat according to the alternate magnetic fields generated by the coil. The susceptor may be arranged to cover at least a portion of an outer circumferential surface of the cigarette 200 inserted into the semi-exterior portion 1100a and may heat the inserted cigarette 200.

As another example, the beater 110 may include an electric resistance heater. For example, the heater 110 may include a film heater arranged to cover at least a portion of an outer circumferential surface of the cigarette 200 inserted into the semi-exterior portion 1100a. The film heater may include an electrically conductive track, and as currents flow through the electrically conductive track, the film heater may generate heat to heat the cigarette 200 inserted into the semi-exterior portion 1100a.

As another example, the heater 110 may include at least one of a needle-type heater, a rod-type heater, and a pipe-type heater capable of heating an inner portion of the cigarette 200 inserted into the semi-exterior portion 1100a. The heater 110 described above may be, for example, inserted into at least one portion of the cigarette 200 and may heat the inner portion of the cigarette 200.

The heater 110 is not limited to the embodiment described above, and according to embodiments, the heater 110 which is capable of heating the cigarette 200 to a designated temperature may vary. In the disclosure, the “designated temperature” may denote a temperature to which an aerosol generating material included in the cigarette 200 may be heated to generate aerosol. The designated temperature may be a temperature predetermined in the aerosol generating device 100. However, the designated temperature may be changed according to a type of the aerosol generating device 100 and/or user manipulation.

The aerosol generating device 100 according to an embodiment may include the antenna 140 and the antenna cover 150 in the semi-exterior portion 1100a. The antenna 140 configured to measure a capacitance of the cartridge 2000 may be arranged to be apart from the cartridge 2000 so as not to directly contact the aerosol generating material, in order to increase the accuracy of measurement. Also, in order to increase the accuracy of measurement, the antenna 140 may be arranged in the semi-exterior portion 1100a so as not to be directly exposed to the outside.

The antenna 140 may be arranged on a surface of the semi-exterior portion 1100a to face a surface of the cartridge 2000. The antenna 140 according to an embodiment may include a single electrode. The capacitance of the cartridge 2000 may be measured by the antenna 140, and from the total amount of capacitance that is measured, whether or not the cover 1000 and the main body 1100 are coupled to each other and the residual quantity of the aerosol generating material may be determined.

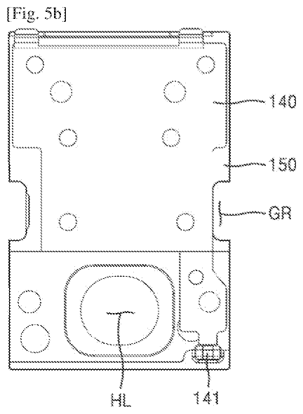

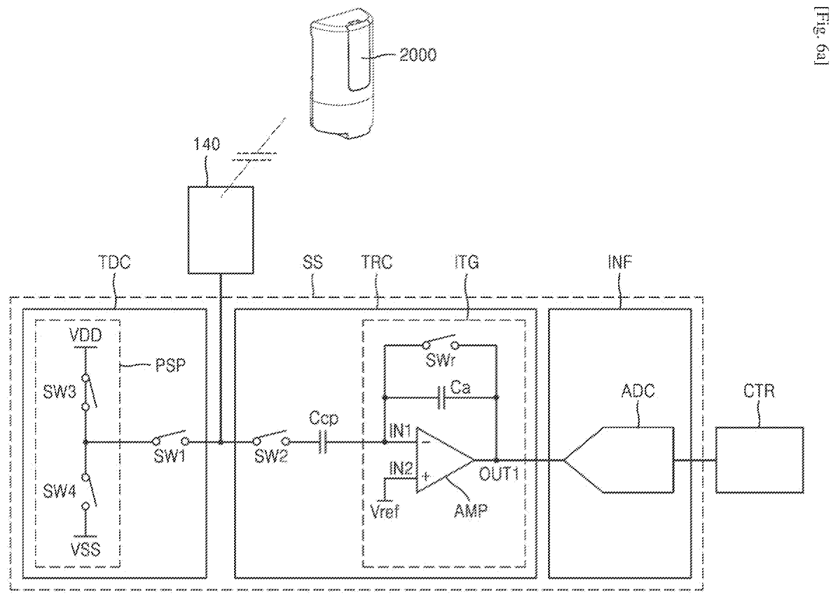

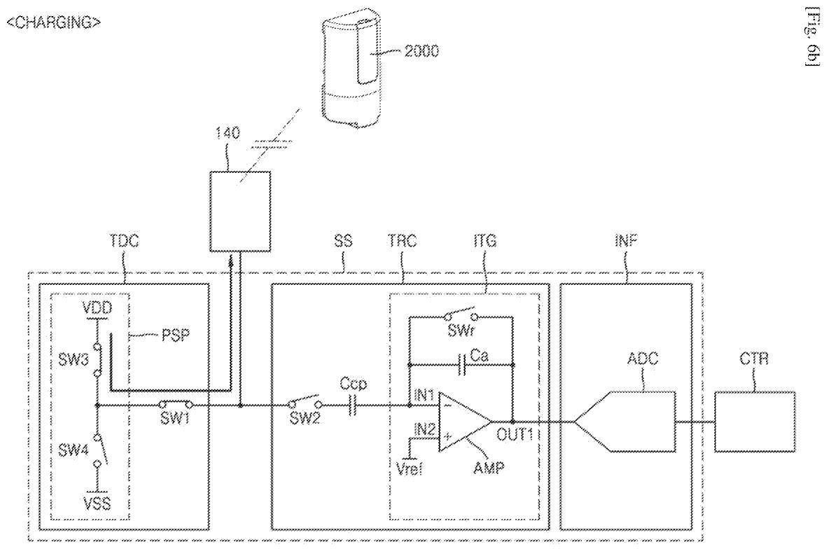

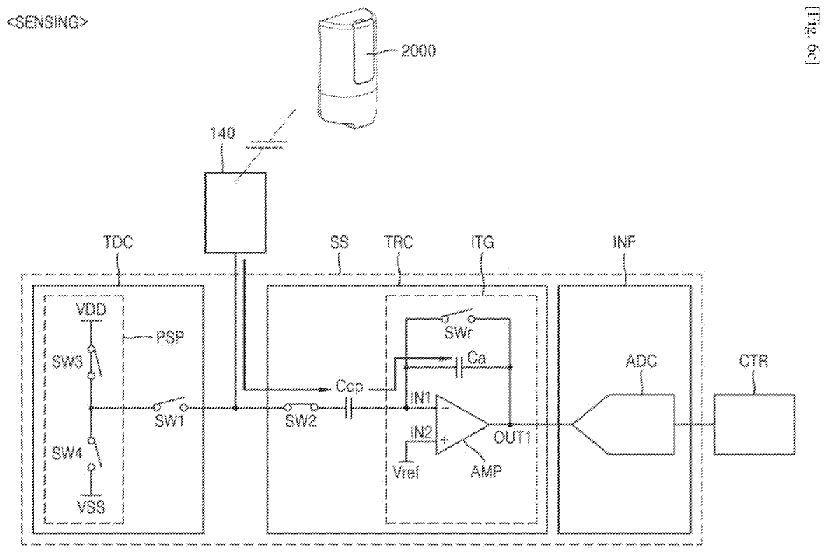

A structural example of the antenna 140 is to be described below with reference to FIGS. 5A and 5B, and a method of detecting the total amount of capacitance of the cartridge 2000 via the antenna 140 and a sensor SS (of FIG. 6A) is to be described below with reference to FIGS. 6A to 6D.

The antenna cover 150 may protect the antenna 140 from the outside. For example, the antenna cover 150 may be arranged to cover at least a portion of the antenna 140 so that the antenna 140 may not be exposed to the outside of the semi-exterior portion 1100a. Thus, the antenna 140 may be protected from external shocks or external impurities (for example, liquid drops, dust, etc.).

A shape of a side surface of the antenna cover 150 may correspond to a shape of a side surface of the cartridge 2000 contacting the antenna cover 150. The antenna 140 may be insert-molded to correspond to the shape of the side surface of the antenna cover 150 formed as described above such that a distance between the antenna 140 and the cartridge 2000. As a distance between the antenna 140 and the cartridge 2000 decreases, the accuracy of measurement of the antenna 140 with respect to the residual quantity of the aerosol generating material may increase.

As the accuracy of measurement of the antenna 140 with respect to the residual quantity of the aerosol increases, more uniform aerosol may be generated. The antenna 140 according to an embodiment may measure the residual quantity of the aerosol generating material in the cartridge 2000, and based on the measured residual quantity, a controller may supply, to the atomizer 2200, power from the battery 120 such that uniform aerosol may be generated. The uniform aerosol may be discharged to the outside through the cigarette 200 through the connection passage 160, and thus a user may have a better smoking experience.

The aerosol generating device 100 may further include the battery 120 and the PCB 130. The battery 120 and the PCB 130 included in the aerosol generating device 100 may be arranged at a bottom end of the aerosol generating device 100. However, the battery 120 and the PCB 130 are not limited thereto, and locations of the components arranged in the aerosol generating device 100 may be changed according to designs. Also, general-purpose components other than the components illustrated in FIG. 3 may further be included in the aerosol generating device 100.

The battery 120 may include a LiFePO4 battery but is not limited thereto. For example, the battery 120 may include a LiCoO2battery, a lithium titanate battery, etc.

The battery 120 may supply power to the atomizer 2200. When the atomizer 2200 includes a wick and a coil, the battery 120 may supply power to the coil surrounding the wick and may heat the aerosol generating material transported through the wick. Also, the battery 120 may supply power required for the antenna 140 and the PCB 130 to operate to the antenna 140 and the PCB 130.

The PCB 130 may be implemented as an array of a plurality of logic gates or may be implemented as a combination of a general-purpose microprocessor and a memory in which a program executable in the microprocessor is stored. The PCB 130 may include a plurality of processing elements. Also, the PCB 130 may also be implemented as other types of hardware.

The processor arranged on the PCB 130 may detect the residual quantity of the aerosol generating material based on the capacitance of the cartridge 2000 measured by the antenna 140. For example, the processor may receive, from the antenna 140, data about the capacitance of the cartridge 2000, and may detect, based on the received data about the capacitance of the cartridge 2000, the residual quantity (or “the residual level”) of the aerosol generating material stored in the cartridge. The processor may determine, according to measured capacitances, the portions of the cartridge 2000 where the aerosol generating material is present.

The processor may detect the residual quantity of the aerosol generating material by using various methods. According to a level of the residual quantity of the aerosol generating material, its corresponding capacitance of the cartridge 2000 may be experimentally pre-determined. Based on a database with respect to a corresponding relationship between the capacitance and the level of the residual quantity, the processor may receive the measured capacitance and output the level of the residual quantity of the aerosol generating material stored in the cartridge 2000. However, the processor is not limited thereto, and the processor may derive the level of the residual quantity of the aerosol generating material stored in the cartridge 2000 according to an algorithm for calculating the level of the residual quantity based on the measured capacitance.

The connection passage 160 may be arranged in the internal space of the semi-exterior portion 1100a and may connect the cigarette 200 and the cartridge 2000 for fluid communication (or fluid connection).

According to an embodiment, the connection passage 160 may be arranged such that aerosol generated from the cartridge 2000 may be discharged to the outside through the cigarette 200. For example, the connection passage 160 may be formed to have an “L” shape and may be arranged to have the cigarette 200 and the cartridge 2000 in fluid communication. However, the shape of the connection passage 160 is not limited to the embodiment described above.

Based on the arrangement structure of the connection passage 160 described above, the cigarette 200 and the cartridge 2000 may be in fluid communication, and as a result, the aerosol generated from the cartridge 2000 may be introduced into the connection passage 160 and may pass through the cigarette 200 to be discharged to the outside of the aerosol generating device 100.

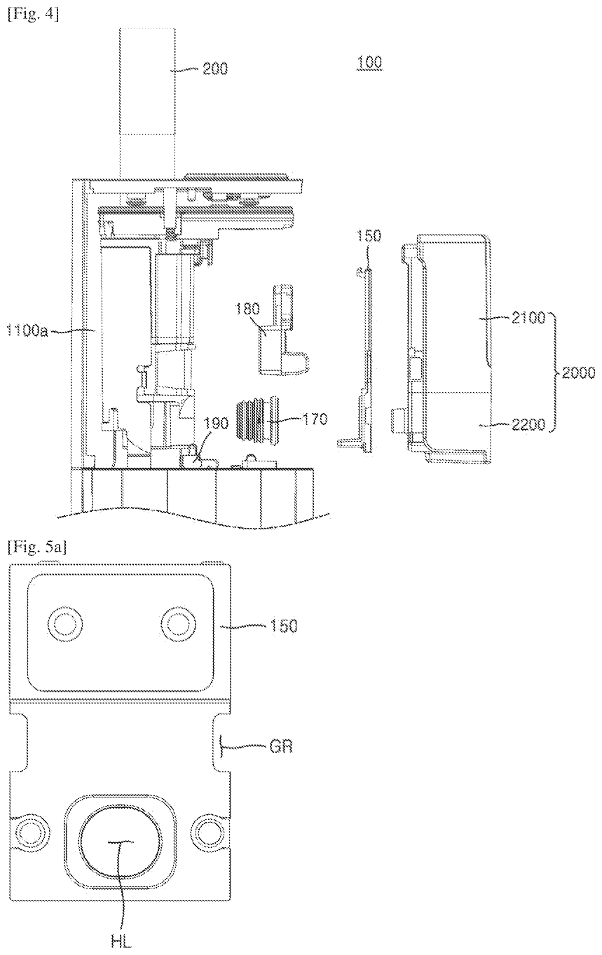

FIG. 4 is an exploded view of some components of an aerosol generating device according to an embodiment.

Referring to FIGS. 3 and 4, the aerosol generating device 100 according to an embodiment may include a sealing portion 170, a cartridge coupling member 180, and an electrical connection member 190 in an internal space of the semi-exterior portion 1100a.

The sealing portion 170 may prevent the leakage of aerosol generated in the cartridge 2000 while the aerosol is transported to the accommodation passage 1100p through the connection passage 160. For example, the aerosol generated in the cartridge 2000 may be introduced into the connection passage 160, and then, may be transported along the connection passage 160 to be transported to the accommodation passage 1100p into which the cigarette 200 is accommodated. When the aerosol is transported along the connection passage 160, at least a portion of the aerosol may be leaked to the outside of the connection passage 160. However, the aerosol generating device 100 according to an embodiment may prevent the leakage of the aerosol through the sealing portion 170 arranged between the cartridge 2000 and the connection passage 160.

The cartridge 2000 may be detachable from the semi-exterior portion 1100a. When the aerosol generating material in the cartridge 2000 is entirely consumed, a user may replace the cartridge 2000.

The aerosol generating device 100 may include the cartridge coupling member 180 for coupling the cartridge 2000 to a portion of the semi-exterior portion 1100a. When the cartridge 2000 is coupled to the aerosol generating device 100, the cartridge coupling member 180 may fix the cartridge 2000 to the aerosol generating device 100.

According to an embodiment, the antenna cover 150 may contact a surface of the antenna 140, and the antenna cover 150 may be arranged between the antenna 140 and the cartridge 2000. The cartridge coupling member 180 may fix the antenna 140 and the antenna cover 150 to the aerosol generating device 100 together with the cartridge 2000.

The electrical connection member 190 may connect the antenna 140 to the PCB 130 arranged below the semi-exterior portion 1100a. The PCB 130 may include a processor (or a controller), and the processor may be connected to the antenna 140 through the electrical connection member 190. Through the electrical connection described above, the processor may receive a sensing signal with respect to a capacitance of the cartridge 2000 from the antenna 140, and based on the received sensing signal, may detect the residual quantity of the aerosol generating material.

FIG. 5A is a view of a surface of an antenna cover. FIG. 5B is a view of another surface of the antenna cover.

Referring to FIGS. 5A and 5B, the antenna 140 according to an embodiment may be arranged such that at least a side surface of the antenna 140 contacts the antenna cover 150. The antenna 140 may be arranged such that the entire side surface of the antenna 140 contacts the antenna cover 150. For example, the antenna 140 may be arranged such that the entire side surface of the antenna 140 may be covered by the antenna cover 150.

According to an embodiment, the antenna 140 and the antenna cover 150 may be integrally formed. For example, when the antenna 140 is insert molded (or “insert injected”) to at least a portion of the antenna cover 150, the antenna 140 and the antenna cover 150 may be integrally formed. When the antenna 140 is insert molded to the antenna cover 150, the entire side surface of the antenna 140 may contact the antenna cover 150. That is, the side surface of the antenna 140 may face the side surface of the antenna cover 150.

The antenna 140 and the antenna cover 150 may include an element (or a “material”) suitable for insert molding. For example, the antenna 140 may include a metal material, and the antenna cover 150 may include a plastic material. However, materials of the antenna 140 and the antenna cover 150 are not limited thereto.

The antenna 140 and the antenna cover 150 according to an embodiment may include a groove GR through which the coupling member 180 (of FIG. 4) may pass and a hole HL through which the sealing portion 170 (of FIG. 4) may pass.

The antenna 140 according to an embodiment may include a single electrode. The single electrode may be a plate-shaped electrode extending in a z direction. The single electrode according to an embodiment may have an area corresponding to an area of a side surface of the storage 2100 of the cartridge 2000, and thus the accuracy of measurement with respect to the residual quantity of the aerosol generating material in the cartridge 2000 may be increased. For example, the single electrode may have the height corresponding to that of the cartridge 2000.

Also, the single electrode may include a contact portion 141 at an end thereof. The contact portion 141 may protrude in a direction (the +x direction of FIG. 3) from the antenna cover 150 toward the heater 110 (of FIG. 3). A portion of the contact portion 141 may be connected to the antenna 140, and another portion of the contact portion 141 may be connected to the electrical connection member 190 (of FIG. 4).

Information about the capacitance of the cartridge 2000 measured by the antenna 140 may be provided to the sensor SS (of FIG. 6A) and a controller CTR (of FIG. 6A) included in the PCB 130 (of FIG. 3) through the contact portion 141 and the electrical connection member 190.

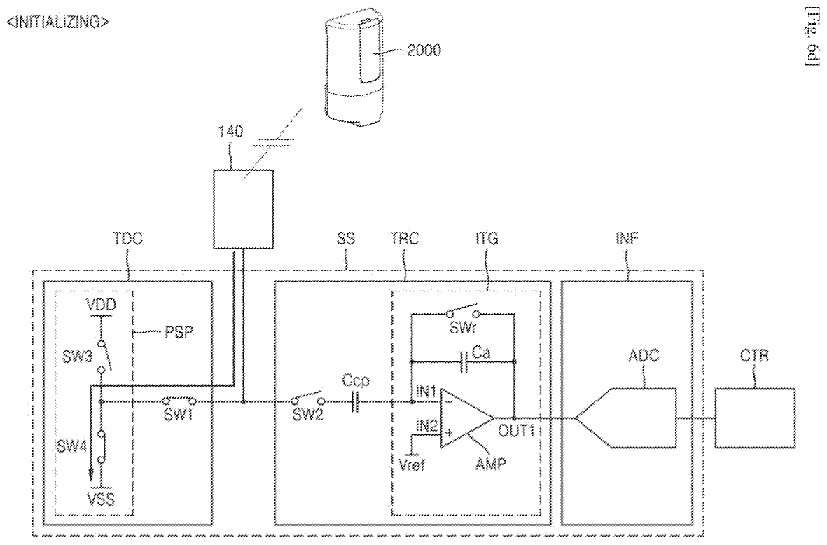

FIG. 6A is a view for describing a sensor according to an embodiment. FIGS. 6B to 6D are views for describing an operation of the sensor according to an embodiment. FIGS. 7A and 7B are graphs showing a change of the total amount of capacitance according to a residual quantity of an aerosol generating material (or a liquid) in a cartridge.

Referring to FIG. 6A, the sensor SS according to an embodiment may include a transmitter TDC, a receiver TRC, and an output interface portion INF.

The transmitter TDC may be configured to supply a driving signal to the antenna 140. The transmitter TDC may be configured to supply the driving signal to the antenna 140 during a first period.

The receiver TRC may be configured to receive a sensing signal from the antenna 140. The receiver TRC may be configured to receive the sensing signal from the antenna 140 during a second period after the first period. The first period and the second period may not overlap each other.

The output interface portion INF may be configured to transmit the sensing signal to the controller CRT. The output interface portion INF may be configured to transmit the sensing signal to the controller CRT during the second period.

The transmitter TDC may include a power supplier PSP and a first switch SW1. The first switch SW1 may connect the power supplier PSP to the antenna 140. The power supplier PSP may supply a driving signal VDD or an initialization signal VSS. A voltage level of the driving signal VDD may be greater than a voltage level of the initialization signal VSS. For example, when a third switch SW3 is turned on, the power supplier PSP may supply the driving signal VDD to an output terminal, and when a fourth switch SW4 is turned on, the power supplier PSP may supply the initialization signal VSS to the output terminal.

The receiver TRC may include an integrator ITG and a second switch SW2. The integrator ITG may output a voltage signal of a voltage level corresponding to a charge amount charged in the antenna 140 to an output terminal OUT1. That is, the integrator ITG may function as a type of sensor channel. The second switch SW2 may connect the integrator ITG with the antenna 140.

For example, the integrator ITG may include an amplifier AMP, a capacitor Ca, and a reset switch SWr. The amplifier AMP may include a first input terminal IN1 connected to the second switch SW2, a second input terminal IN2 receiving a reference voltage Vref, and the output terminal OUT1. For example, the amplifier AMP may include an operational amplifier. For example, the first input terminal IN1 may be an inverting terminal, and the second input terminal IN2 may be a non-inverting terminal. A voltage level of the reference voltage Vref may be greater than a voltage level of the initialization signal VSS and less than a voltage level of the driving signal VDD. The capacitor Ca may connect the first input terminal IN1 with the output terminal OUT1. The reset switch SWr may connect the first input terminal IN1 with the output terminal OUT1. The sensor receiver TRC may further include a coupling capacitor Ccp having a first electrode and a second electrode, which are coupled to the second switch SW2 and the integrator ITG, respectively. The coupling capacitor Ccp may be in a floating state while the second switch SW2 is turned off.

The output interface portion INF may include an analog-to-digital converter ADC. The analog-to-digital converter ADC may receive an output signal of the integrator ITG. The analog-to-digital converter ADC may convert an analog voltage level output by the integrator ITG into a digital value and may output the digital value to the controller CTR.

The controller CTR may receive the output signal of the analog-to-digital converter ADC. The controller CTR may calculate a capacitance of the antenna 140 by using the received digital value.

Referring to FIG. 6B, the first period for charging the antenna 140 is described.

The power supplier PSP may supply the driving signal VDD to the antenna 140 during the first period. For example, as the third switch SW3 is turned on during the first period, the power supplier PSP may supply the driving signal VDD to the antenna 140.

The first switch SW1 may electrically connect the power supplier PSP to the antenna 140 during the first period. That is, the first switch SW1 may be turned on during the first period. Thus, the driving signal VDD may be applied to the antenna 140 during the first period. Here, the second switch SW2 may electrically separate the integrator ITG from the antenna 140 during the first period. That is, the second switch SW2 may be turned off during the first period.

Here, according to the residual quantity of the aerosol generating material (or the liquid) in the cartridge 2000, the magnetic capacitance between the antenna 140 and the cartridge 2000 may vary, and the charge amount of the antenna 140 may become different.

Referring to FIGS. 4A and 7A, the total amount of capacitance between the antenna 140) and the cartridge 2000 may be dependent on the amount of aerosol generating material stored in the storage 2100 of the cartridge 2000. For example, the capacitance may be decreased, as the amount of the aerosol generating material stored in the storage 2100 is decreased.

As illustrated in FIG. 7A, the total amount of capacitance between the antenna 140 and the cartridge 2000 may be smoothly decreased, when a half or more of the aerosol generating material remains in the storage 2100, and may be relatively drastically decreased, when less than a half of the aerosol generating material remains in the storage 2100. In detail, when the storage 2100 is completely filled with the aerosol generating material, the total amount of capacitance between the antenna 140 and the cartridge 2000 may be 100 [pF]. When the storage 2100 is half-filled with the aerosol generating material, the total amount of capacitance between the antenna 140 and the cartridge 2000 may be 90 [pF]. When the storage 2100 is empty, the total amount of the capacitance between the antenna 140 and the cartridge 2000 may be converged to 5 [pF]. Here, even when there is no aerosol generating material at all in the storage 2100, there may be a capacitance between the cartridge 2000 and the antenna 2000. The capacitance (for example, 5 [pF]) in this case may be set as a threshold value to determine whether or not the cartridge 2000 and the main body 1100 are coupled to each other.

Referring to FIG. 6C, the second period for sensing the antenna 140 is described.

The second switch SW2 may electrically connect the integrator ITG with the antenna 140 during the second period after the first period. That is, the second switch SW2 may be turned on during the second period.

The integrator ITG may receive a sensing signal SI from the antenna 140 during the second period. For example, the integrator ITG may output a voltage signal corresponding to a charge amount charged in the antenna 140 to the output terminal OUT1. At the end of the second period, a voltage level of the antenna 140 may be the same as a voltage level of the reference voltage Vref.

Here, the first switch SW1 may electrically separate the power supplier PSP and the antenna 140 from each other during the second period. That is, the first switch SW1 may be turned off during the second period.

The analog-to-digital converter ADC may convert the voltage signal received from the integrator ITG into a digital value and transmit the digital value to the controller CTR, and the controller CTR may calculate the total amount of capacitance of the antenna 140 by using the received digital value. Here, the total amount of capacitance of the antenna 140 may denote the total amount of capacitance between the single electrode and the aerosol generating material.

Referring to FIG. 7B, the controller CTR may determine the residual quantity of the aerosol generating material to be a first level LV1, when the total amount of capacitance corresponds to a first range (for example, 100 [pF] to 92 [pF]), may determine the residual quantity of the aerosol generating material to be a second level LV2, when the total amount of capacitance corresponds to a second range (for example, 92 [pF] to 70 [pF]), and may determine the residual quantity of the aerosol generating material to be a third level LV3, when the total amount of capacitance corresponds to a third range (for example, 70 [pF] to 5 [pF]). Here, since the corresponding capacitance decreases in the order of the first range, the second range, and the third range, it may be determined that the corresponding residual quantity of the aerosol generating material also decreases in the order of the first level LV1, the second level LV2, and the third level LV3.

According to the embodiment illustrated in FIG. 7B, the residual quantities of the aerosol generating material may be arithmetically evenly divided into the first level LV1, the second level LV2, and the third level LV3. That is, the respective ranges of the first level LV1, the second level LV2, and the third level LV3 may be substantially the same. However, the ranges of the levels are not limited thereto. For example, the levels may be divided such that the same heating profile is applied to the same level of residual quantity.

The controller CTR (of FIG. 6A) may control power supplied from the battery 120 (of FIG. 3) to the atomizer 2200, based on the residual quantities of the aerosol generating material (for example, the first level LV1, the second level LV2, and the third level LV3). In the case of the atomizer 2200 including the wick and the coil, if the residual quantity of the aerosol generating material has a relatively higher level (for example, the first level LVI or the second level LV2), the speed at which the aerosol generating material is transported to the outside of the cartridge 2000 along the wick may be high. On the other hand, if the residual quantity of the aerosol generating material has a relatively lower level (for example, the third level LV3), the speed at which the aerosol generating material is transported to the outside of the cartridge 2000 along the wick may be low.

Accordingly, it may be required to supply more power to the coil when the speed of transportation of the aerosol generating material is high and to supply less power to the coil when the speed of transportation of the aerosol generating material is low.

If the supply of power is not correspondingly controlled with the transportation speed of the aerosol generating material, aerosol may be non-uniformly generated from the aerosol generating device 100. Also, if the transportation speed of the aerosol generating material is low, the wick may be burned unless the supply of power is reduced. The controller CTR (of FIG. 6A) may control the power supplied to the coil based on the level of the residual quantity of the aerosol generating material, and thus, the amount of aerosol generated from the aerosol generating device 100 may be maintained uniform, and the quality of aerosol may be improved.

The controller CTR may determine that the cartridge 2000 is separated from the semi-exterior potion 1100a (or the main body 1100), when the total amount of capacitance is less than or equal to a predetermined threshold value (for example, 5 [pF]). As described above, the aerosol generating device 100 according to an embodiment may detect not only the residual quantity, but also whether or not the cartridge 2000 is coupled to the main body 1100, by using the sensor SS (of FIG. 6A) detecting the residual quantity of the aerosol generating material in the cartridge 2000. As such, the effect of reducing power consumption may be expected. If the detachment of the cartridge 2000 from the main body 1100 is to be determined based on the currents flowing between connection electrodes of the cartridge 2000, additional power consumption may be required because currents need to be supplied to the electrodes.

The controller CTR according to an embodiment may sense the total amount of capacitance of the cartridge 2000 by using the antenna 140 and the sensor SS, at a specific time. For example, the controller CTR may sense the capacitance when the cover 1000 (of FIG. 1) is separated from the main body 1100 (of FIG. 1), when the aerosol generating device 100 is turned on, or when the aerosol generating device 100 is turned off. That is, by using the period during which a user does not use the aerosol generating device 100, whether or not the cartridge 2000 is detached or the residual quantity of the aerosol generating material in the cartridge 2000 may be checked.

Referring to FIG. 6D, a third period for initializing the antenna 140 is described.

The first switch SW1 may electrically connect the power supplier PSP with the antenna 140 during the third period after the second period. That is, the first switch SW1 may be turned on during the third period.

The power supplier PSP may supply an initialization signal VSS to the antenna 140 during the third period. For example, when the fourth switch SW4 is turned on during the third period, the power supplier PSP may supply the initialization signal VSS to the antenna 140. Accordingly, at the end of the third period, a voltage level of the antenna 140 may be the same as a voltage level of the initialization signal VSS. For example, the voltage level of the initialization signal VSS may be lower than a voltage level of the reference voltage Vref.

Also, during the third period, a reset switch SWr may be turned on to initialize the charge amount of the capacitor Ca. According to another embodiment, the reset switch SWr may be turned on during a period other than the third period.

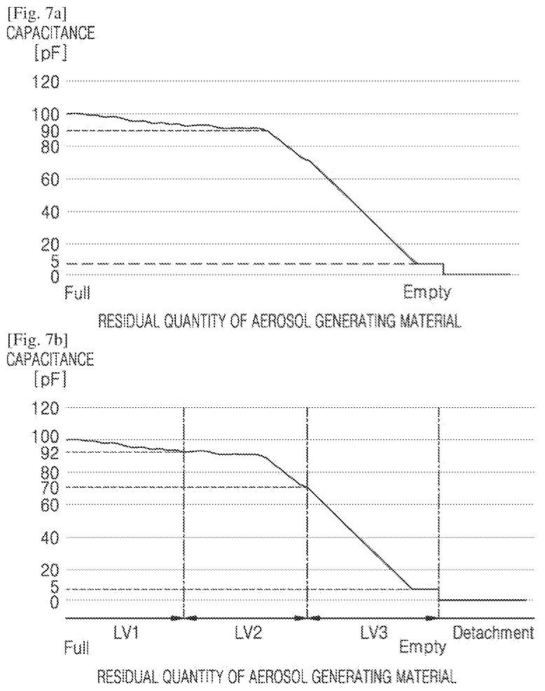

FIG. 8 is a block diagram of an aerosol generating device 8000 according to another embodiment.

The aerosol generating device 8000 may include a controller 8100, a sensing unit 8200, an output unit 8300, a battery 8400, a heater 8500, a user input unit 8600, a memory 8700, and a communication unit 8800. However, the internal structure of the aerosol generating device 8000 is not limited to those illustrated in FIG. 8. That is, according to the design of the aerosol generating device 8000, it will be understood by one of ordinary skill in the art that some of the components shown in FIG. 8 may be omitted or new components may be added.

The sensing unit 8200 may sense a state of the aerosol generating device 8000 and a state around the aerosol generating device 8000, and transmit sensed information to the controller 8100. Based on the sensed information, the controller 8100 may control the aerosol generating device 8000 to perform various functions, such as controlling an operation of the heater 8500, limiting smoking, determining whether an aerosol generating article (e.g., a cigarette, a cartridge, or the like) is inserted, displaying a notification, or the like.

The sensing unit 8200 may include at least one of a temperature sensor 8220, an insertion detection sensor, and a puff sensor 8260, but is not limited thereto.

The temperature sensor 8220 may sense a temperature at which the heater 8500 (or an aerosol generating material) is heated. The aerosol generating device 8000 may include a separate temperature sensor for sensing the temperature of the heater 8500, or the heater 8500 may serve as a temperature sensor. Alternatively, the temperature sensor 8220 may also be arranged around the battery 8400 to monitor the temperature of the battery 8400.

The insertion detection sensor 8240 may sense insertion and/or removal of an aerosol generating article. For example, the insertion detection sensor 8240 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 8260 may sense a user's puff on the basis of various physical changes in an airflow passage or an airflow channel. For example, the puff sensor 8260 may sense a user's puff on the basis of any one of a temperature change, a flow change, a voltage change, and a pressure change.

The sensing unit 8200 may include, in addition to the temperature sensor 8220, the insertion detection sensor 8240, and the puff sensor 8260 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 8300 may output information on a state of the aerosol generating device 8000 and provide the information to a user. The output unit 8300 may include at least one of a display unit 8320, a haptic unit 8340, and a sound output unit 8360, but is not limited thereto. When the display unit 8320 and a touch pad form a layered structure to form a touch screen, the display unit 8320 may also be used as an input device in addition to an output device.

The display unit 8320 may visually provide information about the aerosol generating device 8000 to the user. For example, information about the aerosol generating device 8000 may mean various pieces of information, such as a charging/discharging state of the battery 8400 of the aerosol generating device 8000, a preheating state of the heater 8500, an insertion/removal state of an aerosol generating article, or a state in which the use of the aerosol generating device 8000 is restricted (e.g., sensing of an abnormal object), or the like, and the display unit 8320 may output the information to the outside. The display unit 8320 may be, for example, a liquid crystal display panel (LCD), an organic light-emitting diode (OLED) display panel, or the like. In addition, the display unit 8320 may be in the form of a light-emitting diode (LED) light-emitting device.

The haptic unit 8340 may tactilely provide information about the aerosol generating device 8000 to the user by converting an electrical signal into a mechanical stimulus or an electrical stimulus. For example, the haptic unit 8340 may include a motor, a piezo-electric element, or an electrical stimulation device.

The sound output unit 8360 may audibly provide information about the aerosol generating device 8000 to the user. For example, the sound output unit 8360 may convert an electrical signal into a sound signal and output the same to the outside.

The battery 8400 may supply power used to operate the aerosol generating device 8000. The battery 8400 may supply power such that the heater 8500 may be heated. In addition, the battery 8400 may supply power required for operations of other components (e.g., the sensing unit 8200, the output unit 8300, the user input unit 8600, the memory 8700, and the communication unit 8800) in the aerosol generating device 8000. The battery 8400 may be a rechargeable battery or a disposable battery. For example, the battery 8400 may be a lithium polymer (LiPoly) battery, but is not limited thereto.

The heater 8500 may receive power from the battery 8400 to heat an aerosol generating material. Although not illustrated in FIG. 8, the aerosol generating device 8000 may further include a power conversion circuit (e.g., a direct current (DC)/DC converter) that converts power of the battery 8400 and supplies the same to the heater 8500. In addition, when the aerosol generating device 8000 generates aerosols in an induction heating method. the aerosol generating device 8000 may further include a DC/alternating current (AC) that converts DC power of the battery 8400 into AC power.

The controller 8100, the sensing unit 8200, the output unit 8300, the user input unit 8600, the memory 8700, and the communication unit 8800 may each receive power from the battery 8400 to perform a function. Although not illustrated in FIG. 8, the aerosol generating device 8000 may further include a power conversion circuit that converts power of the battery 8400 to supply the power to respective components, for example, a low dropout (LDO) circuit, or a voltage regulator circuit.

In an embodiment, the heater 8500 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 8500 may be implemented by a metal wire, a metal plate on which an electrically conductive track is arranged. a ceramic heating element, or the like, but is not limited thereto.

In another embodiment, the heater 8500 may be a heater of an induction heating type. For example, the heater 8500 may include a suspector that heats an aerosol generating material by generating heat through a magnetic field applied by a coil.

The user input unit 8600 may receive information input from the user or may output information to the user. For example, the user input unit 8600 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 8, the aerosol generating device 8000 may further include a connection interface, such as a universal serial bus (USB) interface, and may connect to other external devices through the connection interface, such as the USB interface, to transmit and receive information, or to charge the battery 8400.

The memory 8700 is a hardware component that stores various types of data processed in the aerosol generating device 8000, and may store data processed and data to be processed by the controller 8100. The memory 8700 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 8700 may store an operation time of the aerosol generating device 8000, the maximum number of puffs, the current number of puffs, at least one temperature profile, data on a user's smoking pattern, etc.

The communication unit 8800 may include at least one component for communication with another electronic device. For example, the communication unit 8800 may include a short-range wireless communication unit 8820 and a wireless communication unit 8840.

The short-range wireless communication unit 8820 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 8840 may include a cellular network communication unit, an Internet communication unit, a computer network (e.g., local area network (LAN) or wide area network (WAN)) communication unit, or the like, but is not limited thereto. The wireless communication unit 8840 may also identify and authenticate the aerosol generating device 8000 within a communication network by using subscriber information (e.g., International Mobile Subscriber Identifier (IMSI)).

The controller 8100 may control general operations of the aerosol generating device 8000. In an embodiment, the controller 8100 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 8100 may control the temperature of the heater 8500 by controlling supply of power of the battery 8400 to the heater 8500. For example, the controller 8100 may control power supply by controlling switching of a switching element between the battery 8400 and the heater 8500. In another example, a direct heating circuit may also control power supply to the heater 8500 according to a control command of the controller 8100.

The controller 8100 may analyze a result sensed by the sensing unit 8200 and control subsequent processes to be performed. For example, the controller 8100 may control power supplied to the heater 8500 to start or end an operation of the heater 8500 on the basis of a result sensed by the sensing unit 8200. As another example, the controller 8100 may control, based on a result sensed by the sensing unit 8200, an amount of power supplied to the heater 8500 and the time the power is supplied, such that the heater 8500 may be heated to a certain temperature or maintained at an appropriate temperature.

The controller 8100 may control the output unit 8300 on the basis of a result sensed by the sensing unit 8200. For example, when the number of puffs counted through the puff sensor 8260 reaches a preset number, the controller 8100 may notify the user that the aerosol generating device 8000 will soon be terminated through at least one of the display unit 8320, the haptic unit 8340, and the sound output unit 8360.

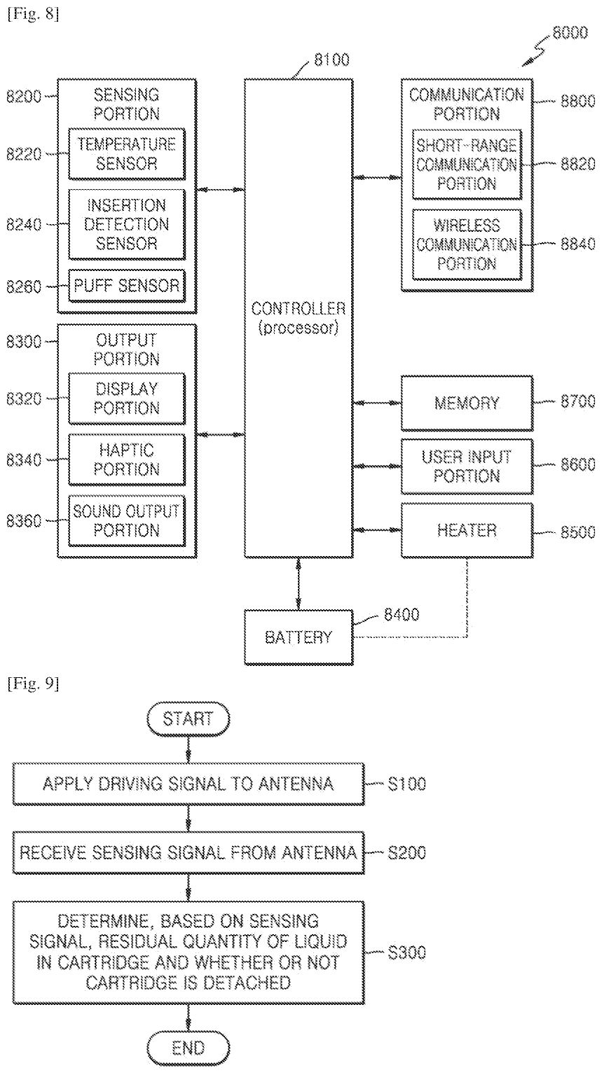

FIG. 9 is a flowchart for describing a method of detecting a residual quantity of an aerosol generating material and determining whether or not a main body is detached in an aerosol generating device.

Referring to FIGS. 1 to 9, an operation method of the aerosol generating device 100 according to an embodiment may include applying (S100) a driving signal to the antenna 140, receiving (S200) a sensing signal from the antenna 140, and determining (S300), based on the sensing signal, the residual quantity of the aerosol generating material (or a liquid) in the cartridge 2000 and whether or not the cartridge 2000 is detached.

Here, the aerosol generating device 100 may include the main body 1100 including the semi-exterior portion 1100a having the accommodation space 1100p into which the cigarette 200 is inserted, the cartridge 2000 detachably coupled to the semi-exterior portion 1100a, the antenna 140 arranged on a surface of the semi-exterior potion 1100a to face a surface of the cartridge 2000, and the sensor SS configured to sense a capacitance of the antenna 140.

The antenna 140 according to an embodiment may include a single electrode. The single electrode may be a plate-shaped electrode extending in a z-axis direction. By using the single electrode as the antenna 120 rather than a plurality of pair electrodes, the total amount of capacitance between the antenna 140 and the cartridge 2000 may be accurately calculated, regardless of an inclination of the aerosol generating device 100.

The single electrode according to an embodiment may have an area corresponding to an area of a side surface of the storage 2100 of the cartridge 2000, and thus, the accuracy of measurement with respect to the residual quantity of the aerosol generating material in the cartridge 2000 may be increased.

Also, the single electrode may include the contact portion 141 at an end thereof. The contact portion 141 may protrude in a direction (the +x direction of FIG. 3) from the antenna cover 150 toward the heater 110 (of FIG. 3). A portion of the contact portion 141 may be connected to the antenna 140, and another portion of the contact portion 141 may be connected to the electrical connection member 190 (of FIG. 4).

Information about the capacitance of the cartridge 2000 measured by the antenna 140 may be provided to the sensor SS (of FIG. 6A) and a controller CTR (of FIG. 6A) included in the PCB 130 (of FIG. 3) through the contact portion 141 and the electrical connection member 190.

The sensor SS according to an embodiment may include the transmitter TDC, the receiver TRC, and the output interface portion INF.

The transmitter TDC may be configured to supply a driving signal to the antenna 140. The transmitter TDC may be configured to supply the driving signal to the antenna 140 during a first period. The transmitter TDC may include the power supplier PSP, the first switch SW1, the third switch SW3, and the fourth switch SW4.

The receiver TRC may be configured to receive a sensing signal from the antenna 140. The receiver TRC may be configured to receive the sensing signal from the antenna 140 during a second period after the first period. The first period and the second period may not overlap each other. The receiver TRC may include the integrator ITG and the second switch SW2. The integrator ITG may include the amplifier AMP, the capacitor Ca, and the reset switch SWr.

The output interface portion INF may be configured to transmit the sensing signal to the controller CRT. The output interface portion INF may be configured to transmit the sensing signal to the controller CRT during the second period. The output interface portion INF may include the analog-to-digital converter ADC.

In operation S100 of applying the driving signal to the antenna 140, the power supplier PSP may supply a driving signal VDD to the antenna 140 during the first period. For example, as the third switch SW3 is turned on during the first period, the power supplier PSP may supply the driving signal VDD to the antenna 140. Here, according to the residual quantity of the aerosol generating material (or the liquid) in the cartridge 2000, the magnetic capacitance between the antenna 140 and the cartridge 2000 may vary, and the charge amount of the antenna 140 may become different.

In operation S200 of receiving the sensing signal from the antenna 140, the second switch SW2 may electrically connect the integrator ITG with the antenna 140 during the second period after the first period. That is, the second switch SW2 may be turned on during the second period. The integrator ITG may receive a sensing signal SI from the antenna 140 during the second period. For example, the integrator ITG may output a voltage signal corresponding to a charge amount charged in the antenna 140 to the output terminal OUT1. The analog-to-digital converter ADC may convert the voltage signal received from the integrator ITG into a digital value and transmit the digital value to the controller CTR, and the controller CTR may calculate the total amount of capacitance of the antenna 140 by using the received digital value. Here, the total amount of capacitance of the antenna 140 may denote the total amount of capacitance between the single electrode and the aerosol generating material.

In operation S300 of determining, based on the sensing signal, the residual quantity of the aerosol generating material (or the liquid) in the cartridge 2000 and whether or not the cartridge 2000 is detached, the controller CTR may determine the residual quantity of the aerosol generating material to be a first level LV1, when the total amount of capacitance corresponds to a first range (for example, 100 [pF] to 92 [pF]), may determine the residual quantity of the aerosol generating material to be a second level LV2, when the total amount of capacitance corresponds to a second range (for example, 92 [pF] to 70 [pF]), and may determine the residual quantity of the aerosol generating material to be a third level LV3, when the total amount of capacitance corresponds to a third range (for example, 70 [pF] to 5 [pF]). Here, since the corresponding capacitance decreases in the order of the first range, the second range, and the third range, it may be determined that the corresponding residual quantity of the aerosol generating material also decreases in the order of the first level LV1, the second level LV2, and the third level LV3.

The controller CTR (of FIG. 6A) may control power supplied from the battery 120 (of FIG. 3) to the atomizer 2200, based on the residual quantities of the aerosol generating material (for example, the first level LV1, the second level LV2, and the third level LV3). In the case of the atomizer 2200 including the wick and the coil, if the residual quantity of the aerosol generating material has a relatively higher level (for example, the first level LV1 or the second level LV2), the speed at which the aerosol generating material is transported to the outside of the cartridge 2000 along the wick may be high. On the other hand, if the residual quantity of the aerosol generating material has a relatively lower level (for example, the third level LV3), the speed at which the aerosol generating material is transported to the outside of the cartridge 2000 along the wick may be low.

Accordingly, it may be required to supply more power to the coil when the speed of transportation of the aerosol generating material is high and to supply less power to the coil when the speed of transportation of the aerosol generating material is low.

If the supply of power is not correspondingly controlled with the transportation speed of the aerosol generating material, aerosol may be non-uniformly generated from the aerosol generating device 100. Also, if the transportation speed of the aerosol generating material is low, the wick may be burned unless the supply of power is reduced. The controller CTR (of FIG. 6A) may control the power supplied to the coil based on the level of the residual quantity of the aerosol generating material, and thus, the amount of aerosol generated from the aerosol generating device 100 may be maintained uniform, and the quality of aerosol may be improved.

The controller CTR may determine that the cartridge 2000 is separated from the semi-exterior potion 1100a (or the main body 1100), when the total amount of capacitance is less than or equal to a predetermined threshold value (for example, 5 [pF]). As described above, the aerosol generating device 100 according to an embodiment may detect not only the residual quantity, but also whether or not the cartridge 2000 is coupled to the main body 1100, by using the sensor SS (of FIG. 6A) detecting the residual quantity of the aerosol generating material in the cartridge 2000. As such, the effect of reducing power consumption may be expected. If the detachment of the cartridge 2000 from the main body 1100 is to be determined based on the currents flowing between connection electrodes of the cartridge 2000, additional power consumption may be required because currents need to be supplied to the electrodes.

The controller CTR according to an embodiment may sense the total amount of capacitance of the cartridge 2000 by using the antenna 140 and the sensor SS, at a specific time. For example, the controller CTR may sense the capacitance when the cover 1000 (of FIG. 1) is separated from the main body 1100 (of FIG. 1), when the aerosol generating device 100 is turned on, or when the aerosol generating device 100 is turned off. That is, by using the period during which a user does not use the aerosol generating device 100, whether or not the cartridge 2000 is detached or the residual quantity of the aerosol generating material in the cartridge 2000 may be checked.

An embodiment may be implemented in the form of a recording medium including a computer-executable instruction, such as a program module executed by a computer. The computer-readable recording medium may be an arbitrary available medium accessible by a computer and includes all of volatile and non-volatile media and detachable and non-detachable media. Also, the computer-readable recording medium may include both of a computer storage medium and a communication medium. The computer storage recording medium includes all of volatile and non-volatile media and detachable and non-detachable media that are realized by an arbitrary method or technique for storing information, such as computer-readable instructions, data structures, program modules, or other data. The communication medium typically includes computer-readable instructions, data structures, program modules, or other data of modulated data signals, or other transmission mechanisms, and includes an arbitrary data transmission mechanism.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a main body including a semi-exterior portion having an accommodation space into which a cigarette is inserted;
a cartridge detachably coupled to the semi-exterior portion;
an antenna arranged on a surface of the semi-exterior portion to face a surface of the cartridge;
a sensor configured to sense a capacitance of the antenna; and
a controller electrically connected to the sensor,
wherein the controller is configured to determine, based on the capacitance, a residual quantity of an aerosol generating material in the cartridge and whether or not the cartridge is detached.

2. The aerosol generating device of claim 1, further comprising an antenna cover arranged between the antenna and the cartridge,
wherein the antenna is arranged on a first surface of the antenna cover, and the surface of the cartridge contacts a second surface of the antenna cover, the second surface being opposite to the first surface.

3. The aerosol generating device of claim 2, wherein the antenna includes a metal material, the antenna cover includes a plastic material, and the antenna and the antenna cover are formed by insert molding.

4. The aerosol generating device of claim 1, wherein the antenna includes a single electrode having a height corresponding to a height of the cartridge.

5. The aerosol generating device of claim 4, wherein the sensor includes:
a transmitter configured to apply a driving signal to the single electrode;
a receiver configured to receive a sensing signal from the single electrode; and
an output interface portion configured to transmit the sensing signal to the controller.

6. The aerosol generating device of claim 5, wherein the controller is further configured to calculate, based on the sensing signal, a total amount of capacitance between the single electrode and the aerosol generating material.

7. The aerosol generating device of claim 6, wherein the controller is further configured to determine that the cartridge is separated from the semi-exterior portion, when the total amount of capacitance is less than or equal to a predetermined threshold value.

8. The aerosol generating device of claim 6, wherein the controller is further configured to determine the residual quantity of the aerosol generating material to be a first level based on the total amount of capacitance being in a first range, determine the residual quantity of the aerosol generating material to be a second level based on the total amount of capacitance being in a second range, and determine the residual quantity of the aerosol generating material to be a third level based on the total amount of capacitance being in a third range.

9. The aerosol generating device of claim 8, wherein, when the capacitance decreases in an order of the first range, the second range, and the third range, the residual quantity of the aerosol generating material decreases in an order of the first level, the second level, and the third level.

10. The aerosol generating device of claim 1, wherein the cartridge includes a storage for storing the aerosol generating material and an atomizer for vaporizing the aerosol generating material.

11. The aerosol generating device of claim 1, further comprising a cover detachably coupled to the main body,
wherein the controller is further configured to sense the capacitance by using the sensor when the cover is separated from the main body, when power is turned on, or when power is turned off.

12. An operating method of an aerosol generating device comprising a main body including a semi-exterior portion having an accommodation space into which a cigarette is inserted, a cartridge detachably coupled to the semi-exterior portion, an antenna arranged on a surface of the semi-exterior portion to face a surface of the cartridge, and a sensor configured to sense a capacitance of the antenna, the operating method comprising:
applying a driving signal to the antenna;
receiving a sensing signal corresponding to the driving signal from the antenna; and
determining, based on the sensing signal, a residual quantity of an aerosol generating material in the cartridge and whether or not the cartridge is detached.

13. The operating method of claim 12, wherein the determining of the residual quantity of the aerosol generating material in the cartridge and whether or not the cartridge is detached includes calculating, based on the sensing signal, a total amount of capacitance between a single electrode and the aerosol generating material.

14. The operating method of claim 13, wherein the determining includes determining that the cartridge is separated from the semi-exterior portion based on the total amount of capacitance being less than or equal to a predetermined threshold value.

15. The operating method of claim 13, wherein the determining includes determining the residual quantity of the aerosol generating material to be a first level based on the total amount of capacitance being in a first range, determining the residual quantity of the aerosol generating material to be a second level based on the total amount of capacitance being in a second range, and determining the residual quantity of the aerosol generating material to be a third level based on the total amount of capacitance being in a third range.
